(19) United States
(12) Patent Application Publication
(10) Pub. No.: US 2021/0187413 A1
(43) Pub. Date: Jun. 24, 2021

(54) SYSTEM, METHOD AND APPARATUS FOR PROCESSING ORGANIC MATERIAL

(71) Applicant: Apeks LLC, Johnstown, OH (US)

(72) Inventors: Ryan Marienau, Johnstown, OH (US); Jeremy Sexton, Johnstown, OH (US); Andy Joseph, Johnstown, OH (US)

(73) Assignee: Apeks LLC, Jonestown, OH (US)

(21) Appl. No.: 17/128,709

(22) Filed: Dec. 21, 2020

Related U.S. Application Data
(60) Provisional application No. 62/953,322, filed on Dec. 24, 2019.

(51) Int. Cl. B01D 11/02; B01D 71/02; B01D 71/06

(52) U.S. Cl. CPC B01D 11/0203; B01D 11/0284; B01D 11/0292; B01D 2325/02; B01D 71/02; B01D 71/06; B01D 11/0288

(57) ABSTRACT

A system for processing organic material can include an extraction system to extract soluble compounds from the organic material using a compressed solvent to form diluted soluble compounds. The system also can include a filter system to pump and filter the diluted soluble compounds through a membrane filter. The membrane filter can remove a retentate comprising undesirable components. The membrane filter also can permit passage of a permeate comprising desirable components and the compressed solvent. The undesirable components comprise a larger molecular weight than the desirable components. The system can further include a depressurization system to depressurize the permeate and allow the compressed solvent to convert from a fluid to a gas. The depressurization system also can separate the desirable components from the gas.

This application claims priority to and the benefit of U.S. Provisional Patent Application No. 62/953,322, filed Dec. 24, 2019 (having attorney docket number 66370-100), which is incorporated herein by reference in its entirety.

### BACKGROUND

The disclosed systems, methods and devices generally relate to processing organic material and using fluid extraction techniques to do so.

### SUMMARY

Embodiments of a system, method and apparatus for processing organic material are disclosed. For example, an extraction apparatus can include an extraction vessel configured to receive a process fluid, permit the process fluid to come into contact with a source material within the extraction vessel, permit an extracted material to be removed from the source material, and permit the extracted material and the process fluid to form a mixture. The extraction vessel can include an extraction vessel filter adapted to retain portions of the source material while also allowing the mixture to pass.

The extraction apparatus can include a separation chamber. The extraction apparatus also can include a process fluid circulation conduit configured to selectively restrict, allow, and reversibly direct flow of the process fluid into and out of the extraction vessel. In addition, it can permit the mixture to flow from the extraction vessel to the separation chamber. The process fluid circulation conduit can include a separation portion configured to receive the mixture and permit a portion of the extracted material to separate from the mixture within the separation chamber.

The extraction apparatus can include a temperature regulator. The temperature regulator can include a temperature regulation fluid and a temperature regulation fluid circulation line. The temperature regulator can be configured to permit re-circulation of the temperature regulation fluid and regulate the temperature of the process fluid.

The extraction apparatus can include a back pressure regulator configured to maintain pressure within the separation chamber and vent the process fluid.

In some examples, the extraction apparatus can include a heating source configured to heat the process fluid prior to ingress of the process fluid into the extraction vessel. The fluid can be carbon dioxide or other solvents, such as similar solvents.

In some examples, the extraction apparatus can include a heat exchanger configured to regulate temperature of the process fluid prior to ingress of the process fluid into the extraction vessel.

In some examples, the extraction apparatus can include an extraction vessel temperature regulator. In some examples, the extraction apparatus can include a separation chamber temperature regulator.

In some examples, of the extraction apparatus, the process fluid used can be carbon dioxide. In some examples, of the extraction apparatus, the process fluid can be supercritical carbon dioxide. In some examples, of the extraction apparatus, the source material can be a botanical substance. In some examples, of the extraction apparatus, the extracted material can include at least one of a botanical oil and a wax, fats, lipids, chlorophyll, etc., as part of the extracted material.

In some examples, of the extraction apparatus, the process fluid circulation conduit can include valves configured to selectively restrict, allow, and reversibly direct flow of the process fluid through the process fluid circulation conduit. In addition to extraction apparatus, embodiments can include filter and separation apparatus such as a loop with valves for the filter and separation apparatus.

In some examples, of the extraction apparatus, the extraction vessel can include a first extraction vessel filter and a second extraction vessel filter. In some examples, the extraction apparatus can be configured to permit reversal of a direction of flow of the process fluid through the first extraction vessel filter and the second extraction vessel filter.

In some examples, of the extraction apparatus, the separation portion can include an orifice. In some examples, of the extraction apparatus, the separation portion can be orientated to direct the process fluid along an inner wall of the separation chamber in a generally rotational manner. In some examples, of the extraction apparatus, the orifice can be sized to match a flow rate of the process fluid. In some examples a membrane filter can be applied to an additional separator to be used to separate fats, waxes, lipids from desired products.

A re-circulating extraction apparatus can include an extraction vessel configured to receive a process fluid, permit the process fluid to come into contact with a source material within the extraction vessel, permit an extracted material to be removed from the source material, and permit the extracted material and the process fluid to form a mixture. The extraction vessel can include a filter adapted to retain portions of the source material while also allowing the mixture to pass. In some examples a separator can be used to separate the process fluid from the desired oil. Some process fluid(s) can be separated via a membrane filter and others can be separated via phase transformation.

The re-circulating extraction apparatus can include a separation chamber. The re-circulating extraction apparatus can include an overflow chamber.

The re-circulating extraction apparatus can include a process fluid circulation conduit configured to selectively restrict, allow, and reversibly direct flow of the process fluid into and out of the extraction vessel, permit the mixture to flow from the extraction vessel to the separation chamber, permit the process fluid to flow from the separation vessel to the overflow chamber, and permit re-circulation of the process fluid. The process fluid circulation conduit can include a separation portion configured to receive the mixture and permit a portion of the extracted material to separate from the mixture within the separation chamber.

The re-circulating extraction apparatus can include a temperature regulator. The temperature regulator can include a temperature regulation fluid and a temperature regulation fluid circulation line. The temperature regulator can be configured to permit re-circulation of the temperature regulation fluid and regulate the temperature of the process fluid.

The re-circulating extraction apparatus can include a pump configured to increase or maintain the pressure and/or the flowrate of the process fluid. The filter apparatus can include a pump to deliver crude oil to and from membrane.

In some examples, the re-circulating extraction apparatus can include a heating source configured to heat the process fluid prior to ingress of the process fluid into the extraction vessel.

In some examples, the re-circulating extraction apparatus can include a heat exchanger configured to regulate temperature of the process fluid prior to ingress of the process fluid into the extraction vessel.

In some examples, the re-circulating extraction apparatus can include a regenerative heat exchanger.

In some examples, the re-circulating extraction apparatus can include an extraction vessel temperature regulator. In some examples, the re-circulating extraction apparatus can include a separation chamber temperature regulator. In some examples, the re-circulating extraction apparatus can include an overflow chamber temperature regulator.

In some examples, of the re-circulating extraction apparatus, the process fluid can include carbon dioxide. In some examples, of the re-circulating extraction apparatus, the process fluid can include supercritical carbon dioxide. In some examples, of the re-circulating extraction apparatus, the source material can include a botanical substance. In some examples, of the re-circulating extraction apparatus, the extracted material can include at least one of a botanical oil and a wax, other solvents, fats, lipids, chlorophyll, etc.

In some examples, of the re-circulating extraction apparatus, the process fluid circulation conduit can include valves configured to selectively restrict, allow, and reversibly direct flow of the process fluid through the process fluid circulation conduit. The filter apparatus also can have valves.

In some examples, of the re-circulating extraction apparatus, the extraction vessel can include a first extraction vessel filter and a second extraction vessel filter. In some examples, the re-circulating extraction apparatus can be configured to permit reversal of a direction of flow of the process fluid through the first extraction vessel filter and the second extraction vessel filter.

In some examples, of the re-circulating extraction apparatus, the separation portion can include an orifice. In some examples, of the re-circulating extraction apparatus, the separation portion can be orientated to direct the process fluid along an inner wall of the separation chamber in a generally rotational manner. In some examples, of the re-circulating extraction apparatus, the orifice can be sized to match a flow rate of the process fluid. In some examples a filter apparatus can be applied.

The foregoing and other objects and advantages of these embodiments will be apparent to those of ordinary skill in the art in view of the following detailed description, taken in conjunction with the appended claims and the accompanying drawings.

### BRIEF DESCRIPTION OF THE DRAWINGS

So that the manner in which the features and advantages of the embodiments are attained and can be understood in more detail, a more particular description can be had by reference to the embodiments thereof that are illustrated in the appended drawings. However, the drawings illustrate only some embodiments and therefore are not to be considered limiting in scope as there can be other equally effective embodiments.

FIG. 1 is a schematic diagram of an embodiment of an extraction system.

FIG. 2 is a perspective view of an embodiment of an extraction system.

FIG. 3 is a schematic diagram of another embodiment of an extraction system.

FIGS. 4A-4C are sectional side, top and bottom views, respectively, of an embodiment of an extraction vessel.

FIGS. 5A-5C are sectional side, top and bottom views, respectively, of another embodiment of an extraction vessel.

FIGS. 6A-6C are sectional side, top and bottom views, respectively, of an embodiment of a separation chamber.

FIGS. 7A-7C are sectional side, top and bottom views, respectively, of an embodiment of an overflow chamber.

FIG. 8 is a perspective view of still another embodiment of an extraction system.

FIG. 9 is a schematic diagram of an embodiment of a membrane filtration system.

FIG. 10 is a CO₂ phase diagram that depicts membrane filtration pressures and operating temperatures, for some embodiments.

FIG. 11 includes schematic diagrams of embodiments of a processing system.

FIG. 12 includes schematic diagrams of embodiments of membrane filtration processing.

### DETAILED DESCRIPTION

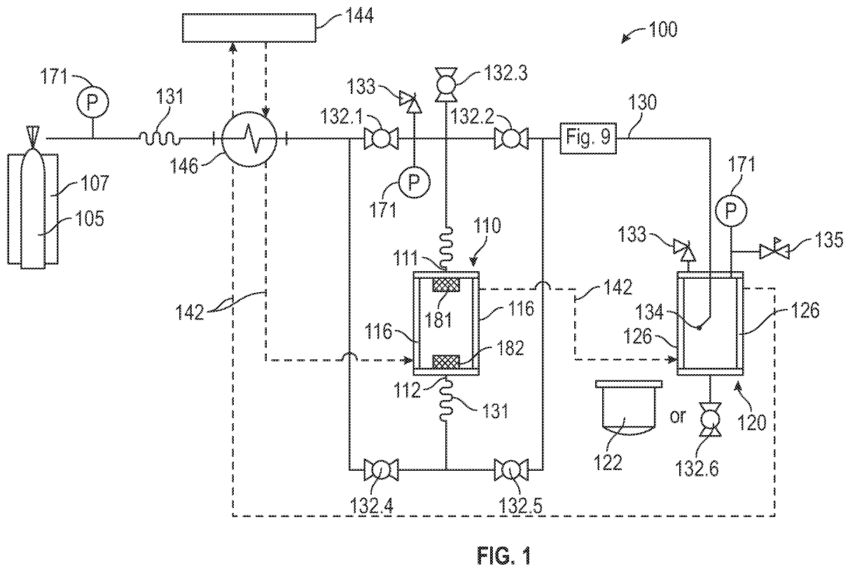

FIGS. 1-12 depict various embodiments of a system, method and apparatus for processing organic material. Several examples, of systems configured to perform extraction are disclosed. In each example, the systems can be configured to permit a process fluid to be in contact with a source material, whereby an extracted material is removed from the source material, forming a mixture with the process fluid.

In some examples, the process fluid can be carbon dioxide. In some examples, the process fluid can be supercritical carbon dioxide. The process fluid can any other fluid suitable for forming a mixture when placed in contact with the source material. Optionally, certain additives can be included in the process fluid, for example, ethanol.

In some examples, the source material can be a botanical substance. In some examples, the extracted material can include at least one of a botanical oil and a wax. In other examples, the source material can be any material in which extraction is desired. For example, the source material could be any physical article such as an instrument, tool, medical device, or implant. By operation of the disclosed systems, manufacturing fluids or other forms of residue can be removed from the surface of the physical article.

As shown in FIG. 1, an extraction apparatus 100 can include an extraction vessel 110 configured to receive a process fluid, permit the process fluid to come into contact with a source material within the extraction vessel 110, permit an extracted material to be removed from the source material, and permit the extracted material and the process fluid to form a mixture.

In some examples, the extraction vessel 110 can comprise a volume of about one liter, and it can be rated at a maximum pressure of about 1500 pounds per square inch (psi) at about 200 degrees F. Other pressure and temperature ratings can be used. For example, the pressure and temperature ratings can be anything that causes CO₂ to be in subcritical or supercritical fluid phase. Moreover, the extraction vessel 110 can comprise any volume.

In some examples, the extraction vessel 110 can have an opening for receiving the process fluid. In some examples, the extraction vessel can have multiple openings for receiving the process fluid. In the example shown in FIG. 1, the extraction vessel 110 includes a first extraction vessel opening 111 and a second extraction vessel opening 112. In some examples, the openings of the extraction vessel can be sealed using an elastomeric O-ring. One example of a suitable elastomeric O-ring is a Buna-90 O-ring.

The extraction vessel 110 can include an extraction vessel filter adapted to retain portions of the source material while also allowing the mixture to pass. In some examples, the extraction vessel 110 can have one or more filters. As shown in FIG. 1, the extraction vessel 110 can include a first extraction vessel filter 181 located near the first extraction vessel opening 111 and a second extraction vessel filter 182 located near the second extraction vessel opening 112.

The extraction apparatus 100 can include a separation chamber 120. In some examples, the separation chamber 120 can be rated for about 500 psi at 200° F. In some examples, the filter chamber can be rated for subcritical and/or supercritical CO₂. Versions of the separation chamber 120 can be designed for any rating that allows for a gaseous phase.

The extraction apparatus 100 can include a process fluid circulation conduit 130 configured to selectively restrict, allow, and reversibly direct flow of the process fluid into and out of the extraction vessel 110 and permit the mixture to flow from the extraction vessel 110 to the separation chamber 120. The process fluid circulation conduit 130 can be stainless steel in some examples. In other examples, the process fluid circulation conduit 130 can be made from one of a family of austenitic nickel-chromium based alloys, such as those supplied commercially under the brand name Inconel by Special Metals Corporation. In other examples, the process fluid circulation conduit 130 can be made from other suitable material for high corrosion resistance. In other examples, the process fluid circulation conduit 130 can be steel or another suitable material for applications with low sanitary requirements. In some examples, the process fluid circulation conduit 130 can be sized about 304 stainless steel (SS) with about ⅜ inches diameter, and a wall thickness of about 0.035 inches. The process fluid circulation conduit 130 can include flexible portions 131.

The process fluid circulation conduit 130 can include one or more valves configured to selectively restrict, allow, and reverse a direction of flow of the process fluid through the process fluid circulation conduit 130 and other portions of the extraction apparatus 100. In some examples, the valves can be temperature rated from about 22 F to about 356 F.

In some examples, the process fluid circulation conduit 130 can be configured with a system of valves to selectively direct an amount of the process fluid to remain within the extraction vessel 110 for a desired time. For example, this can allow the extraction process to be completed to a desired extent. In some versions, the extraction apparatus 100 can be configured with a system of valves to permit reversal of a direction of flow of the process fluid through the extraction vessel 110. In some examples, the reversal of the direction of flow of the process fluid through the extraction vessel 110 can facilitate cleaning or clearing of the first and second extraction vessel filters 181 and 182 without interrupting ongoing extraction processing. Flushing and/or cleaning membranes can be included. Valves can be used to direct fluid to flush/clean the membranes. Embodiments of the membranes are enabled for back flushing to clean the membrane surfaces.

In some examples, the system of valves can include one or more pairs of opposing valves for directing the flow of process fluid. In the example of FIG. 1, the first, second, third, fourth, and fifth valves, labeled 132.1, 132.2, 132.3, 132.4, and 132.5 respectively, can be positioned along the process fluid circulation conduit 130 as shown. To direct process fluid into the extraction vessel 110 at a first extraction vessel opening 111, the first valve 132.1 can be opened while the second valve 132.2 can be closed. To direct the process fluid out of the extraction vessel 110 and further downstream in the system, the second valve 132.2 can be opened while the first vale 131.1 can be closed. The third valve, 132.3, can be used to decompress the system and vent process fluid out of the system.

In the example of FIG. 1, the fourth and fifth valves, 132.4 and 132.5, can be configured to direct the process fluid into or out of a second extraction vessel opening 113. Optionally, the valves could be used to direct the process fluid into or out of multiple openings of the extraction vessel 110. For example, by opening the first valve 132.1 and fifth valve 132.5 while closing the downstream second valve 132.2 and fourth valve 132.4, the process fluid can be directed into the first extraction vessel opening 111 and out of the second extraction vessel opening 112. By closing the first valve 132.1 and fifth valve 132.5 while opening the second valve 132.2 and fourth valve 132.4, the process fluid can be directed into the second extraction vessel opening 112 and out of the first extraction vessel opening 111.

In the example apparatus depicted in FIG. 1, the process fluid can be directed in a first direction of flow such that the process fluid enters the extraction vessel 110 through extraction vessel opening 111, passing through the extraction vessel filter 181. According to this direction of flow, the process fluid can pass through an interior portion of the extraction vessel 110 where it can come into contact with the source material, extract the extracted material, and form the mixture. The mixture can then be directed to pass through filter 182 and exit the extraction vessel 110 at opening 112. Optionally, the valves can be re-configured such that the direction of flow of the process fluid and/or mixture can be reversed, allowing the process fluid and/or mixture to enter the extraction vessel 110 at extraction vessel opening 112, pass through the extraction vessel filter 182, pass through filter 181, and exit at extraction vessel opening 111.

The process fluid circulation conduit 130 can include a separation portion 134 configured to receive the mixture and permit a portion of the extracted material to separate from the mixture within the separation chamber 120. In some examples, the separation portion 134 can allow the process fluid to decompress in the separation chamber 120 and separate the extracted material from the process fluid without the use of a valve or regulator for separation.

In some examples, the separation portion 134 can include an orifice. The orifice can be sized to match a flow rate of the process fluid. In some examples, the orifice can be about 0.010 inches in diameter. In some examples, the orifice can restrict the flow of process fluid, allowing a significant pressure drop in the mixture after passing through the orifice and allowing the process fluid to change from a subcritical or supercritical state to a gaseous state, thereby allowing the extracted material to fall out, or separate, from the process fluid.

In some examples, the separation portion 134 can be positioned near an inner wall of the separation chamber 120. In some examples, the separation portion 134 can be orientated to direct the process fluid along the inner wall of the separation chamber 120 in a generally rotational manner. In some examples, a portion of process fluid circulation conduit 130 leading to the separation portion 134 can be angled at an appropriate angle, which can be about 45 degrees. In some examples, the inner wall of the separation chamber 120 can be relatively warmer than an interior portion of the separation chamber 120. In some examples, directing the process fluid along the inner wall of the separation chamber 120 in a generally rotational manner can help to keep the process fluid in a gaseous state after the process fluid is depressurized in the separation chamber 120. In such examples, the relatively warmer inner wall can help to counteract the Joule-Thompson cooling effect that can occur when the process fluid decompresses.

In some examples, a separation process can be executed via a membrane filter.

In some examples, the extraction apparatus 100 can be configured to receive the process fluid from a process fluid storage container 105, which can be a cylinder or any other storage device capable of holding the process fluid.

An initial state of the process fluid in the process fluid storage container 105 can be solid, liquid, gaseous, or supercritical. Where the process fluid is in an initial liquid state, a siphon can be optionally used to remove the process fluid from a top opening of the process fluid storage container while maintaining consistent pressure. Alternatively, the liquid process fluid can be removed by inverting the process fluid storage container 105 such that the opening is on the bottom.

In some examples, the extraction apparatus 110 can include a heating source 107 configured to heat the process fluid prior to ingress of the process fluid into the extraction vessel 110. In some examples, heating source 107 can heat the process fluid within the process fluid storage container 105. The heating source 107 can be a heating blanket, electric band heater, induction heater, coiled tubing with heating fluid in intimate contact, or an open flame.

In some examples, as the process fluid is heated by the heating source 107, a temperature and the internal pressure of the process fluid rises. In this way, a desired pressure for the process fluid in the system can be achieved without the need for a pump. If necessary, the heating source 107 can deliver continuous or recurring heat to the process fluid so as to maintain the pressure within the system.

Optionally, the temperature and internal pressure of the process fluid can be increased to the point of allowing a phase transformation of the process fluid. Optionally, this phase transformation can occur within the process fluid storage container 105. When the initial state of the process fluid is liquid or gas, increasing the temperature and pressure above the fluid's critical point can allow a phase change to a supercritical state. For example, heating carbon dioxide above about 87 F at a pressure above about 1083 psi will result in a phase change to a supercritical state.

The extraction apparatus 100 can include a temperature regulator. The temperature regulator can include a temperature regulation fluid and a temperature regulation fluid circulation line 142. In the example shown in FIG. 1, the temperature regulator can include a chiller/heater 144 with temperature regulation fluid circulation line 142 running through the extraction apparatus 100 to regulate temperature of the process fluid.

The temperature regulator can be configured to permit re-circulation of the temperature regulation fluid. The temperature regulation fluid circulation line 142 can run in close proximity to the process fluid circulation conduit 142. In some examples, the circulation line can form a coil around the temperature regulation fluid circulation line 142.

In some examples, the temperature regulation fluid can be liquid water, steam or another heating/cooling fluid. In some examples, the temperature regulation fluid can include distilled water. In some examples, the temperature regulation fluid can be a mixture, for example, a mixture of about 50% water and about 50% glycol.

The temperature regulator can be configured to raise, lower, or maintain the temperature of the process fluid prior to introduction into the extraction vessel 110 to achieve a desired temperature. In some examples, the temperature regulator can be configured to optionally cause a phase change in the process fluid prior to entering the extraction vessel 110.

In some examples, temperature regulator can include a heat exchanger 146 configured to regulate temperature of the process fluid prior to ingress of the process fluid into the extraction vessel 110. In some examples, the heat exchanger 146 can be a tube-in-tube configuration, allowing the process fluid to be in close physical proximity to the temperature regulation fluid, thereby allowing for the exchange of heat between the two fluids while maintaining their separation from one another. Alternative configurations of the heat exchanger 146 could include a shell and tube design, a coil design, or any other method of heat exchange.

In some examples, the temperature regulator can be configured to regulate the temperature of the process fluid within the extraction vessel 110. In some versions, the temperature regulator can be configured to regulate the temperature of the process fluid within the separation chamber 120. As shown in the example of FIG. 1, the extraction apparatus 100 can include an extraction vessel temperature regulator 116 and a separation chamber temperature regulator 126. As shown in this example, the temperature regulation fluid circulation line 142 can extend to the extraction vessel temperature regulator 116 and the separation chamber temperature regulator 126. In the example shown in FIG. 1, the system can be configured to permit the temperature regulation fluid to flow through the temperature regulation fluid circulation line 142, through the extraction vessel temperature regulator 116, through the temperature regulation fluid circulation line 142, through the separation chamber temperature regulator 126, and through the temperature regulation fluid circulation line 142. In some examples, the extraction vessel temperature regulator 116 can be a heating/cooling jacket surrounding an exterior portion of extraction vessel 110. In some examples, the separation chamber temperature regulator 126 can be a heating/cooling jacket surrounding an exterior portion of separation chamber 120. In some embodiments, the filtration vessel 310 can have a temperature regulator that can be a heating/cooling jacket surrounding an exterior portion of the filtration vessel 310.

In some examples, the temperature regulator can regulate the temperature of the process fluid in other portions of the process fluid circulation conduit 130. In one example, a portion of the process fluid circulation conduit 130 connecting the extraction vessel 110 with the separation chamber 120 could run in close proximity to the temperature regulation fluid circulation line 142. Alternative configurations could include a shell and tube design, a coil design, or any other method of heat exchange. Any other portion of the process fluid circulation conduit 130 could be regulated in the same ways.

In some examples, the extraction apparatus 100 can include a back pressure regulator 135 configured to maintain pressure within the separation chamber 120 and vent the process fluid. In some examples, the backpressure regulator 135 can be located at a discharge opening of the separation chamber 120.

In some examples, a collection cup 122 can be used to capture the extracted material after separation from the process fluid in the separation chamber 120.

In other examples, a valve, such as the sixth valve 132.6 shown in FIG. 1, can be used to direct the extracted material out of the separation chamber 120 after separation from the process fluid. Optionally, the extracted material can be directed out of the separation chamber 120 while the separation chamber 120 remains under pressure.

As shown in FIG. 1, the extraction apparatus 100 can include one or more pressure gauges 171. As shown in FIG. 1, the extraction apparatus 100 can include one or more relief valves 133. As shown in FIG. 1, the extraction apparatus 100 can include one or more relief valves 133.

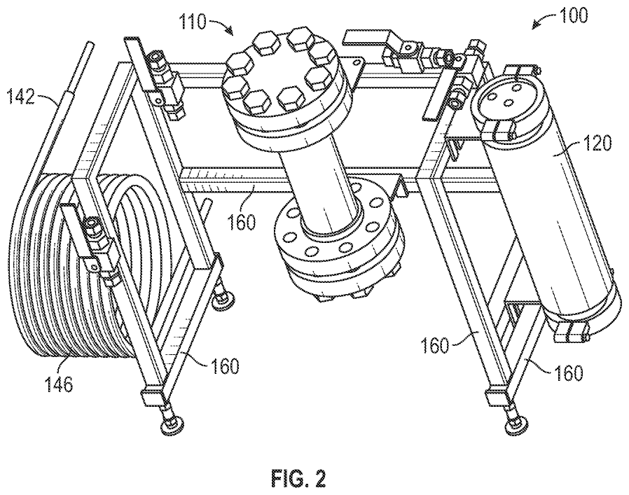

In the example shown in FIG. 2, some of the described aspects of the extraction apparatus 100 are shown mounted on a frame 160 in an exemplary arrangement.

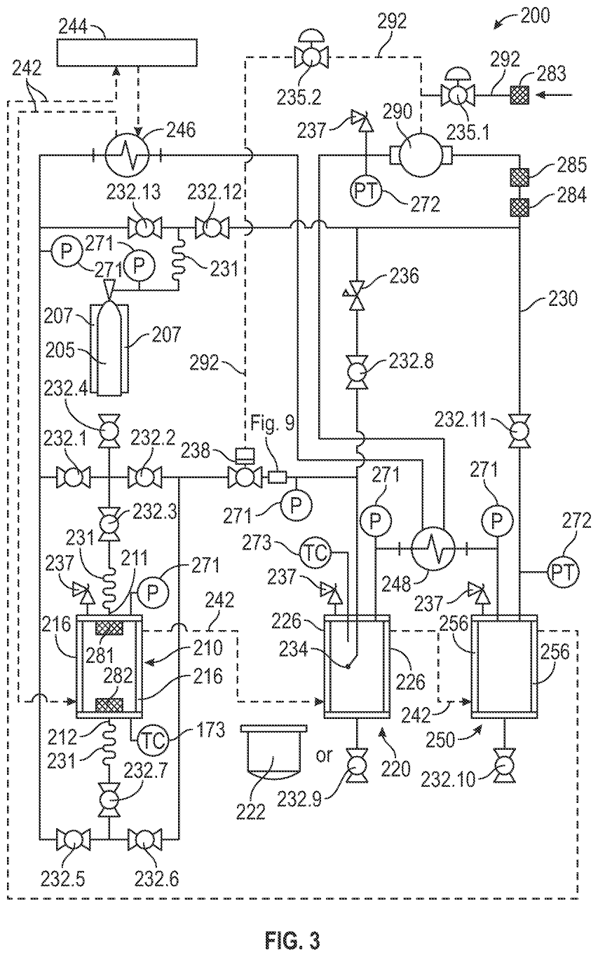

As shown in FIG. 3, a re-circulating extraction apparatus 200 can include an extraction vessel 210 configured to receive a process fluid, permit the process fluid to come into contact with a source material within the extraction vessel 210, permit an extracted material to be removed from the source material, and permit the extracted material and the process fluid to form a mixture.

In some examples, the extraction vessel 210 can have an opening for receiving the process fluid. In some examples, the extraction vessel can have multiple openings for receiving the process fluid. In the example shown in FIG. 3, the extraction vessel 210 includes a first extraction vessel opening 211 and a second extraction vessel opening 212. In some examples, the openings of the extraction vessel can be sealed using an appropriate O-ring, such as an elastomeric O-ring. One example of a suitable elastomeric O-ring can be a Buna-90 O-ring.

The extraction vessel 210 can include an extraction vessel filter adapted to retain portions of the source material while also allowing the mixture to pass. In some examples, the extraction vessel 210 can have a multiple filters. As shown in FIG. 3, the extraction vessel 210 can include a first extraction vessel filter 281 located near the first extraction vessel opening 211 and a second extraction vessel filter 282 located near the second extraction vessel opening 212.

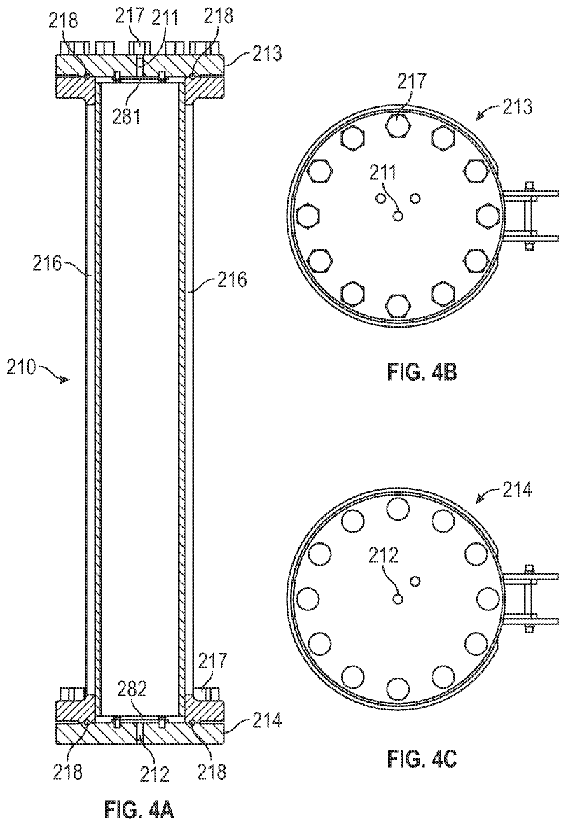

In the example shown in FIGS. 4A, 4B, and 4C, the extraction vessel 210 can include an interior portion sounded by an extraction vessel temperature regulator 216, with a first flange 213 and a second flange 214. As also shown in FIG. 4A, O-rings 218 can be used to seal the first and second flanges 213 and 214 of the extraction vessel 210. As also shown in FIG. 4A, the first and second extraction vessel filters 281 and 282 can be located near the first and second extraction vessel openings 211 and 212 respectively.

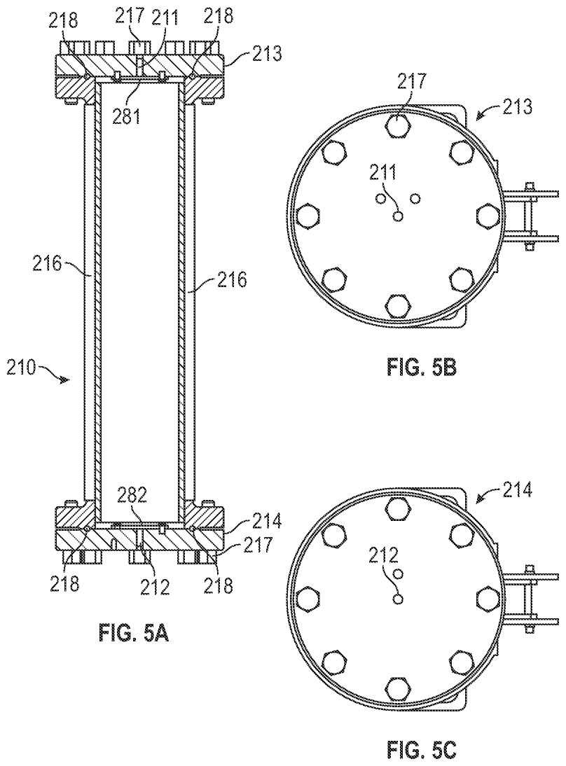

As shown in FIG. 4B, the first flange 213 can have one or more openings, which may include the first extraction vessel opening 211. As shown in FIG. 4C, the second flange 214 can have one or more openings, which may include the second extraction vessel opening 212. In some examples, the top and bottom flanges can be secured with bolts 217. In some examples, the volume of the extraction vessel 210 can be about 20 liters, and it can be rated to a maximum pressure of about 1500 psi at about 200° F. In other examples, the extraction vessel 210 can have a volume of about 5 liters, and it can be rated to a maximum pressure of about 1500 psi at about 200° F. FIGS. 5A, 5B, and 5C show another example configuration of extraction vessel 210, top flange 213, and bottom flange 214. In some embodiments, the vessel openings can be any design that can meet the required temperature and pressure parameters to induce a subcritical or supercritical phase.

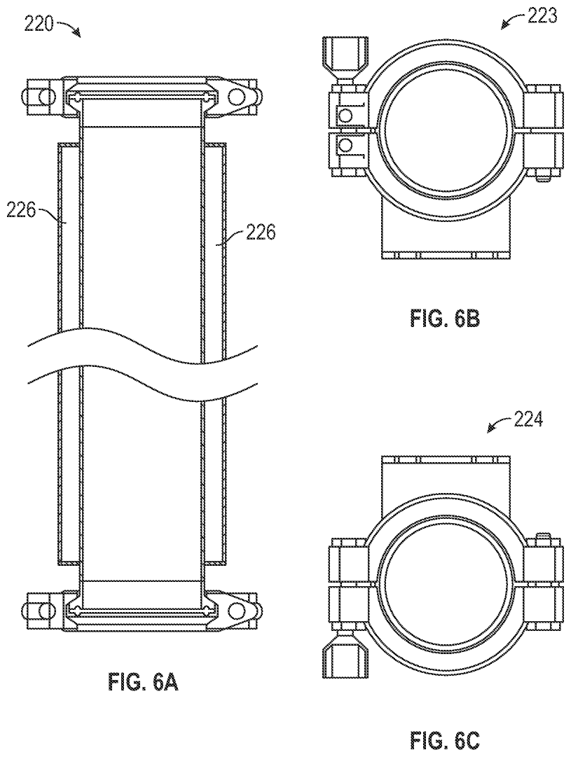

The re-circulating extraction apparatus 200 can include a separation chamber 220. As shown in FIG. 6A, the separation chamber 220 can have an interior portion, surrounded by a separation chamber temperature regulator 226. As shown in FIGS. 6B and 6C, the separation chamber 220 can have a first cap 223 and a second cap 224. In some examples, the separation chamber 220 can be rated for about 500 psi at about 200 F. In some examples, the pressure and temperature can be in super and/or subcritical ranges.

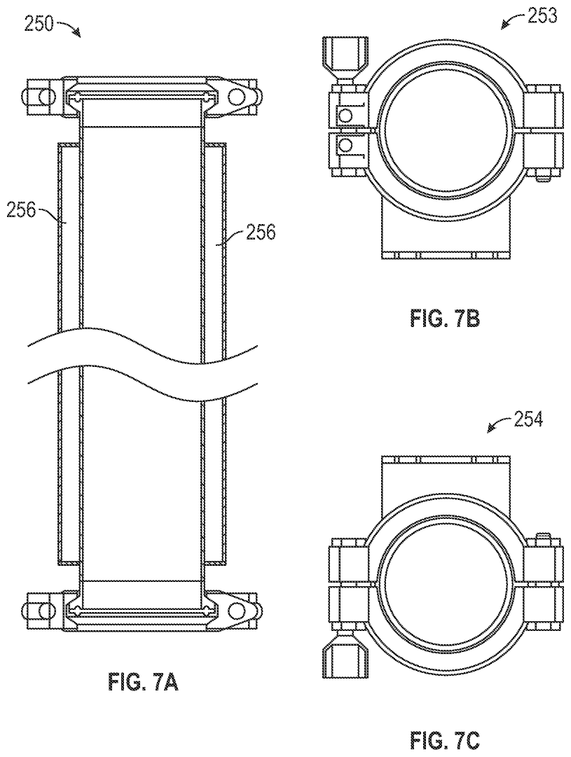

The re-circulating extraction apparatus 200 can include an overflow chamber 250. As shown in FIG. 7A, the overflow chamber 250 can have an interior portion, surrounded by an overflow temperature regulator 256. As shown in FIGS. 7B and 7C, the overflow chamber 250 can have a first cap 253 and a second cap 254. In some examples, the overflow chamber 250 can be rated for about 500 psi at 200 F.

The re-circulating extraction apparatus 200 can include a process fluid circulation conduit 230 configured to selectively restrict, allow, and reversibly direct flow of the process fluid into and out of the extraction vessel 210. The process fluid circulation conduit 230 can also be configured to permit the mixture to flow from the extraction vessel 210 to the separation chamber 220. The process fluid circulation conduit 230 can also be configured to permit the process fluid to be re-circulated through the extraction vessel 210, separation chamber 220, and overflow chamber 250.

The process fluid circulation conduit 230 can be stainless steel in some examples. In other examples, the process fluid circulation conduit 230 can be made from one of a family of austenitic nickel-chromium based alloys, such as those supplied commercially under the brand name Inconel by Special Metals Corporation. In other examples, the process fluid circulation conduit 230 can be made from and other suitable material for high corrosion resistance. In other examples, the process fluid circulation conduit 230 can be steel or another suitable material for applications with low sanitary requirements. In some examples, the process fluid circulation conduit 230 can be sized about 304 stainless steel (SS) with about ⅜ inches diameter, and a wall thickness of about 0.035 inches. The process fluid circulation conduit 230 can include flexible portions 231.

In some examples, a pump 290 can be configured to create a desired pressure and to help circulate the process fluid through the system and to recover the process fluid for re-circulation. Any type of pump suitable for use with the chosen process fluid could be used, including pumps of varying configurations and which can use particular liquids or gases and be air driven or electrically driven. In some examples, the pump 290 can be an air driven gas booster. In some examples, the pump 290 may operate with a pump fluid, which may be air or any other suitable fluid.

In some examples, the pump 290 may circulate the pump fluid through a pump fluid circulation line 292. As shown in the example of FIG. 3, the pump fluid circulation line 292 can be configured with one or more valves, such as solenoid valves 235.1, 235.2, 235.3, and safety valve 238. As also shown in FIG. 3, the pump fluid circulation line 292 can be configured with one or more filters, such as pump fluid intake filter 283.

The process fluid circulation conduit 230 can include one or more valves configured to selectively restrict, allow, and reverse a direction of flow of the process fluid through the process fluid circulation conduit 230 and other portions of the re-circulating extraction apparatus 200. In one example arrangement shown in FIG. 3, the system of valves can include thirteen valves, labeled 232.1, 232.2, 232.3, 232.4, 232.5, 232.6, 232.7, 232.8, 232.9, 232.10, 232.11, 232.12, 232.13, configured to selectively restrict, allow, and reverse a direction of flow of the process fluid through the process fluid circulation conduit 230 and other portions of the re-circulating extraction apparatus 200. In some examples, the valves can be rated from about −22 degrees F. to about 356 degrees F.

In some examples, the process fluid circulation conduit 230 can be configured with a system of valves to selectively direct the process fluid to flow within the extraction vessel 210 for a desired time, for example, to allow the extraction process to be completed to a desired extent. In some examples, the re-circulating extraction apparatus 200 can be configured with a system of valves to permit reversal of a direction of flow of the process fluid through the extraction vessel 210. In some examples, the reversal of the direction of flow of the process fluid through the extraction vessel 210 can facilitate cleaning or clearing of first and second extraction vessel filters 281 and 282 without interrupting ongoing extraction processing. In some examples, the system of valves can include one or more pairs of opposing valves for directing the flow of process fluid.

In the example apparatus depicted in FIG. 3, the process fluid can be directed in a first direction of flow such that the process fluid enters the extraction vessel 210 through extraction vessel opening 211, passing through extraction vessel filter 212. According to this direct direction of flow, the process fluid can pass through an interior portion of the extraction vessel 210 where it can come into contact with the source material, extract the extracted material, and form the mixture. The mixture can then be directed to exit the extraction vessel 210 at opening 213 and passing through filter 214. Optionally, the valves can be re-configured such that the direction of flow of the process fluid and/or mixture to be reversed, causing the process fluid and/or mixture to enter the extraction vessel 210 at extraction vessel opening 213, pass through extraction vessel filter 214, exit opening 211 and pass through filter 212.

As shown in FIG. 3, the re-circulating extraction apparatus 200 can include one or more relief valves 237 to selectively allow the depressurization of fluid at one or more locations within the re-circulating extraction apparatus 200. As shown in FIG. 3, the re-circulating extraction apparatus 200 can include one or more regulating valves 236. As shown in FIG. 3, the re-circulating extraction apparatus 200 can include one or more solenoid valves 235. The apparatus can be configured to redirect flow to flush membrane.

The process fluid circulation conduit 230 can include a separation portion 234 configured to receive the mixture and permit a portion of the extracted material to separate from the mixture within the separation chamber 220. In some examples, the separation portion 234 can allow the process fluid to decompress in the separation chamber 220 and separate the extracted material from the process fluid without the use of a valve or regulator for separation.

In some examples, the separation portion 234 can include an orifice. The orifice can be sized to match a flow rate of the process fluid. In some examples, the orifice can be about 0.010 inches in diameter. In some examples, the orifice can restrict the flow of process fluid, allowing a significant pressure drop in the mixture after passing through the orifice and allowing the process fluid to change from a subcritical or supercritical state to a gaseous state, thereby allowing the extracted material to fall out, or separate, from the process fluid.

In some examples, the separation portion 234 can be positioned near an inner wall of the separation chamber 220. In some examples, the separation portion 234 can be orientated to direct the process fluid along the inner wall of the separation chamber 220 in a generally rotational manner. In some examples, a portion of process fluid circulation conduit 230 leading to the separation portion 234 can be angled at an appropriate angle, which can be about 45 degrees. In some examples, the inner wall of the separation chamber 220 can be relatively warmer than an interior portion of the separation chamber 220. In some examples, directing the process fluid along the inner wall of the separation chamber 220 in a generally rotational manner can help to keep the process fluid in a gaseous state after the process fluid is depressurized in the separation chamber 220. In such examples, the relatively warmer inner wall can help to counteract the Joule-Thompson cooling effect that can occur when the process fluid decompresses. Membrane filtration can be used for separation.

In some examples, the re-circulating extraction apparatus 200 can be configured to receive the process fluid from a process fluid storage container 205, which can be a cylinder or any other storage device capable of holding the process fluid.

In some examples, the extraction apparatus 210 can include a heating source 207 configured to heat the process fluid prior to ingress of the process fluid into the extraction vessel 210. In some examples, heating source 207 can heat the process fluid within a process fluid storage container 205. The heating source can be a heating blanket, electric band heater, induction heater, coiled tubing with heating fluid in intimate contact, or an open flame.

In some examples, as the process fluid can be heated by the heating source 207, a temperature and the internal pressure of the process fluid rises. If necessary, the heating source 207 can deliver continuous or recurring heat to the process fluid so as to help maintain the pressure within the system.

Optionally, the temperature and internal pressure of the process fluid can be increased to the point of causing a phase transformation of the process fluid. Optionally, this phase transformation can occur within the process fluid storage container 205. When the initial state of the process fluid is liquid or gas, increasing the temperature and pressure above the fluid's critical point will cause a phase change to a supercritical state. For example, heating carbon dioxide above about 87° F. at a pressure above about 1083 psi can result in a phase change to a supercritical state.

The initial state of the process fluid in the process fluid storage container 205 can be solid, liquid, gaseous, or supercritical. Where the process fluid is in an initial liquid state, a siphon can be optionally used to remove the process fluid from a top opening of the process fluid storage container while maintaining consistent pressure. Alternatively, the liquid process fluid can be removed by inverting the process fluid storage container 205 such that the opening is on the bottom.

The re-circulating extraction apparatus 200 can include a temperature regulator. The temperature regulator can include a temperature regulation fluid and a temperature regulation fluid circulation line 242. In the example shown in FIG. 3, the temperature regulator can include a chiller/heater 244 with temperature regulation fluid circulation line 242 running through the re-circulating extraction apparatus 200 to regulate temperature of the process fluid in various locations of the re-circulating extraction apparatus 200.

The temperature regulator can be configured to permit re-circulation of the temperature regulation fluid. In some examples, the temperature regulation fluid can be liquid water, steam or another other heating/cooling fluids. The temperature regulation fluid circulation line 242 can run in close proximity to the process fluid circulation conduit 242. In some examples, the circulation line can form a coil around the temperature regulation fluid circulation line 242.

The temperature regulator can be configured to raise, lower, or maintain the temperature of the process fluid prior to introduction into the extraction vessel 210 to achieve a desired temperature. In some examples, the temperature regulator can be configured to optionally cause a phase change in the process fluid prior to entering the extraction vessel 210.

As shown in the example of FIG. 3, the temperature regulator can include a heat exchanger 246 configured to regulate temperature of the process fluid prior to ingress of the process fluid into the extraction vessel 210. In some examples, the heat exchanger 246 can be a tube-in-tube configuration, allowing the process fluid to be in close physical proximity to the temperature regulation fluid, thereby allowing for the exchange of heat between the two fluids while maintaining their separation from one another. Alternative configurations of the heat exchanger 246 could include a shell and tube design, a coil design, or any other method of heat exchange.

In some examples, a regenerative heat exchanger can be configured to help regulate the temperature of process fluid at the beginning and the end of the closed-loop re-circulating system. In some examples, the regenerative heat exchanger can use heat generated from the compression of process fluid by the pump at the beginning of the cycle to offset Joule-Thompson cooling that can occur when the process fluid decompresses in the separation chamber.

In the example shown in FIG. 3, a regenerative heat exchanger 248 comprises two portions of the process fluid circulation conduit 230 running in close proximity to one another to transfer heat from a relatively warm portion of the process fluid circulation conduit 230 to a relatively cool portion of the process fluid circulation conduit 230. In some examples, the regenerative heat exchanger 248 can be a tube-in-tube configuration, allowing a relatively warm portion of the process fluid to be in close physical proximity to a relatively cool portion of the process fluid, thereby allowing for the exchange of heat between the two portions while maintaining their separation from one another. Alternative configurations of the heat exchanger 248 could include a shell and tube design, a coil design, or any other method of heat exchange.

In some examples, the temperature regulator can be configured to regulate the temperature of the process fluid within the extraction vessel 210. In some examples, temperature regulator can be configured to regulate the temperature of the process fluid within the separation chamber 220. As shown in the example of FIG. 3, the re-circulating extraction apparatus 200 can include an extraction vessel temperature regulator 216, a separation chamber temperature regulator 226, and an overflow chamber temperature regulator 256. As shown in this example, the temperature regulation fluid circulation line 242 can extend to the extraction vessel temperature regulator 216, the separation chamber temperature regulator 226, and the overflow chamber temperature regulator 256 and allow the temperature regulation fluid to flow through each of these components. In some examples, the temperature regulators 216, 226, and 256 can be a heating/cooling jacket. Alternative configurations could include a shell and tube design, a coil design, or any other method of heat exchange.

In some examples, the temperature regulator can regulate the temperature of the process fluid in other portions of the process fluid circulation conduit 230. In one example, a portion of the process fluid circulation conduit 230 connecting the extraction vessel 210 with the separation chamber 220 could run in close proximity to the temperature regulation fluid circulation line 242. Alternative configurations could include a shell and tube design, a coil design, or any other method of heat exchange. Any other portion of the process fluid circulation conduit 230 could be regulated in the same ways.

In some examples, a collection cup 222 can be used to capture the extracted material after separation from the process fluid in the separation chamber 220.

In other examples, a valve, such valve 232.9 shown in FIG. 3, can be used to direct the extracted material out of the separation chamber 220 after separation from the process fluid while the separation chamber 220 remains under pressure. In some examples valves and a pump can be used to direct the extracted material into a separation chamber utilizing a membrane filter.

As shown in FIG. 3, the re-circulating extraction apparatus 200 can include one or more pressure gauges 271 to indicate a pressure of fluid at one or more locations within the re-circulating extraction apparatus 200. As shown in FIG. 3, the re-circulating extraction apparatus 200 can include one or pressure transducers 272 to sense a pressure of fluid at one or more locations within the re-circulating extraction apparatus 200. As shown in FIG. 3, the re-circulating extraction apparatus 200 can include one or more thermocouples 273 to sense a temperature of fluid at one or more locations within the re-circulating extraction apparatus 200.

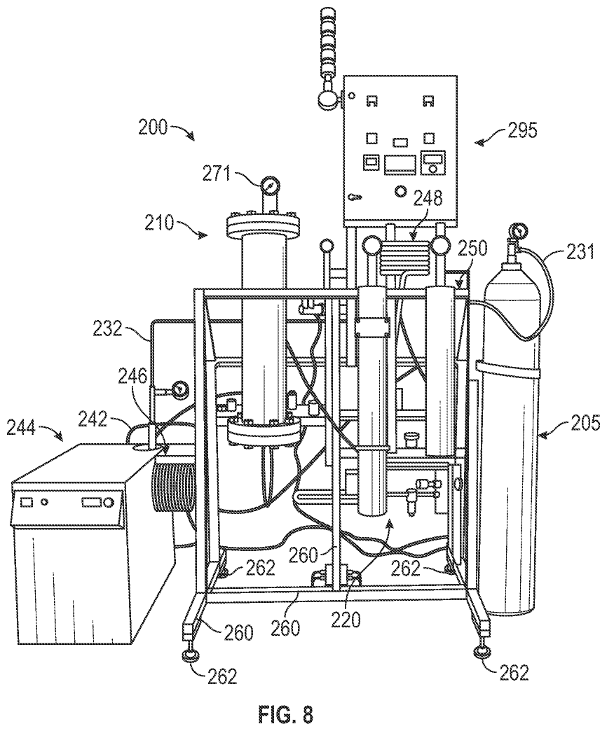

In the example shown in FIG. 8, some of the described aspects of the re-circulating extraction apparatus 200 are shown mounted on a frame 260 in an exemplary arrangement. In some examples, a system scale 262 can be incorporated into the apparatus 200 below the frame 260.

In some examples, the extraction apparatus 100 and re-circulating extraction apparatus 200 can display system parameters such as temperature, pressure, and time. In some examples, the extraction apparatus 100 and re-circulating extraction apparatus 200 can receive data on system parameters from one more sensors. For example, in the apparatus shown in FIG. 1, pressure can be displayed on pressure gauges 171. Optionally, pressure and other system parameters can be displayed on an electronic control panel or other suitable display mechanism. In the example shown in FIG. 3, a control panel could display pressure data received from sensor such as pressure gauges 271 and pressure transducers 272. The control panel could also display temperature data received from sensor such as thermocouples 173.

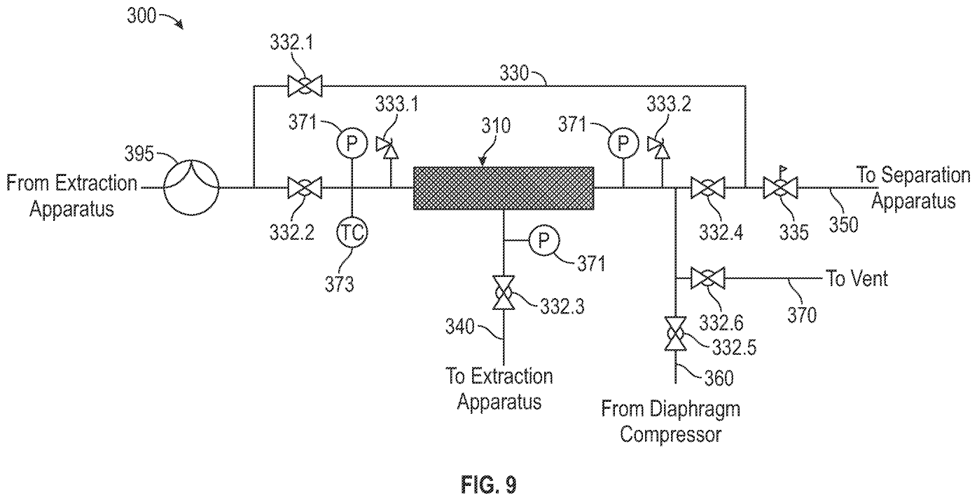

In some examples, the filtration apparatus 300 can display system parameters such as temperature, pressure, and time. In some examples, the filtration apparatus 300 can receive data on system parameters from one or more sensors. For example, the apparatus shown in FIG. 9, pressure can be displayed on pressure gauges 371. Optionally, pressure and other system parameters can be displayed on an electronic control panel or other suitable display mechanism. In the example shown in FIG. 3, a control panel could display pressure data received from sensor such as pressure gauges 271 and pressure transducers 272. The control panel could also display temperature data received from sensor such as thermocouple 173 and 373.

In some examples, various aspects of the operation of the extraction apparatus 100 and re-circulating extraction apparatus 200 can be automated with a control system. The control system can include electronic components and mechanical components. In some examples, the control system can be configured to automate the operation of the system based upon data supplied by sensors or based upon the lapse of time. For example, in the device shown in FIG. 3, the control system could be configured to turn on or off the chiller/heater 244 or the pump 290, in response to data supplied by the sensors or the lapse of time. The system could also be configured to implement certain other logical operations helpful in system operation. For example, the control system can be configured to run certain operations for a certain elapsed period of time or based upon certain data received from sensors and thereafter perform a desired function or set of functions, such as open or close certain valves. In the example of FIG. 3, the control system could be configured to open or close any of valves 232.1 through 232.13, any of the relief valves 233, any of the solenoid valves 135, any of the regulating valves 136, and any of the safety valves 138. For example, in the device shown in FIG. 9, the control system could be configured to control feed, retentate, and permeate pressures. Control of these pressures lead to the control of the transmembrane pressure of the membrane filter. In the example of FIG. 9, the control system could be configured to open or close any of valves 332.2 through 332.6.

In the example shown in FIG. 8, the apparatus 200 can have a control box 295 that can include either or both of the control panel and control system. The control box could be electrically connected to the various sensors and system components of the apparatus 200.

Examples, of methods of operating the system disclosed in FIG. 3 will now be disclosed. As an initial state, the system can be confirmed to be clean.

The extraction vessel 210 can be opened with the following steps. Close valves 232.1 and 232.2. Open valves 232.3 and 232.4. Remove bolts on the top of the extraction vessel 210, for example using a 1.5″ impact socket and impact wrench. Lift the flange and allow it to rest in the open position on the stops.

The extraction vessel 210 can be loaded with source material, optionally with a funnel to avoid spillage. The source material can be prepared in a desired fashion. For example, the source material could be ground, gently compressed, or otherwise prepared. The system scale 262 can be used to weigh the amount of source material loaded.

Once the desired amount of source material is loaded, the extraction vessel can be closed and sealed. In some examples, the sealing surfaces can be checked to be clean and generally free of debris. In some examples, O-rings can be inspected for any visible damage or defects and replaced as necessary. In some examples, the O-rings do not require lubrication. In some examples, an extraction vessel flanges 213 and 214 can be closed and closure bolts 217 installed.

The filtration vessel 310 can be opened before, during, or after a run. To open the filtration vessel during a run, open valve 332.1 and close valve 332.2 through 332.4. Open valve 332.6. Remove bolts on the ends of the filtration vessel 310. Remove the clamping mechanism and remove the vessel cap. To open the filtration vessel before or after a run, remove bolts on the ends of the filtration vessel 310. Remove the clamping mechanism and remove the vessel cap.

The filtration vessel 310 can be loaded or unloaded with one or more membrane filters. In some examples ceramic membranes can installed or removed. In some examples polymer membranes can be installed or removed. Membranes are installed or removed from either end of the filtration vessel 310. Membrane filters can be sealed within the filtration vessel 310 on one end or both ends depending on the membrane design. If the membrane filter has a seal on one end, the seal should be orientated to allow for permeate and retentate to flow to the fluid permeate line 350 and the fluid retentate line 340 respectively.

Once the desired membrane is installed, the filtration vessel can be closed and sealed. In some examples, the sealing surfaces can be checked to be clean and generally free of debris. In some examples, O-rings can be inspected for any visible damage or defects and replaced as necessary. In some examples, the O-rings do not require lubrication. In some examples, a filtration vessel flange can be closed and closure bolts installed.

The re-circulating extraction apparatus 200 can be evaluated for moisture or other fluids. The following valves can be opened: 232.1, 232.2, 232.3, 232.5, 232.10, 232.11, 232.12, and 232.13. A pump can be connected to valve 232.10 and the system pumped down to a desired pressure, for example 20-25 in Hg. This pressure can be held for several minutes to ensure no gross leaks and to remove moisture. All valves can be closed and the pump disconnected from valve 232.10.

Process fluid can be filled according to the following steps. Tare the scale by pushing a “tare/reset” key. Open a valve on the process fluid storage container 205. Open valves 232.1, 232.3, 232.5, and 232.7. Pressurize and fill extraction vessel 210 by slowly opening valve 232.13. Extraction vessel 210 can be pressurized from both top and bottom. Allow extraction vessel 210 pressure to equalize with the pressure in the process fluid storage container 205. Shut valves 232.5 and 232.13. Pressurize the separation chamber 220 and overflow chamber 250 to 300 psi by opening valve 232.12 and throttling valve 232.11. Close valve 232.11 when pressure in the separation chamber 220 and overflow chamber 250 is approximately 300 psi. Increase extraction vessel 210 pressure by turning the switch to “START” on control panel. Once extraction vessel 210 pressure has reached desired pressure, open valve 232.6. Shut valve 232.12. Open valve 232.11. Allow system to stabilize for approximately 5 minutes.

At this stage in the example method, the system can be now circulating process fluid 210 and extracting. It may be necessary to adjust the amount of process fluid 210 in the system to maintain a desired extraction pressure. To increase pressure in the extraction vessel 201, the following steps can be performed. Shut valve 232.11. Open valve 232.12 until extraction vessel 210 reaches the desired pressure or the separation chamber 220 or overflow chamber 250 reach 450 psi. Shut valve 232.12. Open valve 232.11. Allow the system to stabilize, and repeat as necessary. To decrease pressure in the extraction vessel 210, the following steps can be performed. Shut one of valves 232.1 and 232.5 (only one of them will be open). Throttle valve 232.13 and allow the extraction vessel pressure to decrease to a desired level. Shut valve 232.13. Open one of valves 232.1 or 232.5 (whichever was previously opened).

In the example shown in FIG. 3, the process fluid 210 can flow through the process fluid circulation conduit 230 according to the following path: (1) out of the left side of the pump 290, (2) down to the regenerative heat exchanger 248, (3) up and over to the heat exchanger 246, (4) through the extraction chamber 210, (5) through the safety valve 238, (6) through the separation portion 234 within in the separator chamber 220, (7) to the regenerative heat exchanger 248, (8) through the overflow chamber 250, (9) through filters 284 and 285, and (10) back up to the pump 290.

In the example shown in FIG. 3, the temperature regulation fluid can flow through the temperature regulation fluid circulation line according to the following path: (1) out of the chiller/heater 244, (2) through the temperature heat exchanger 246, (3) through the extraction vessel temperature regulator 216, (4) through the separation chamber temperature regulator 226, (5) through the overflow chamber temperature regulator 226, and (6) back up to the chiller/heater 244.

Multiple separate temperature regulation fluid circulation lines (e.g., chillers/heaters) can be implemented. One line can take the following path: (1) out of the chiller/heater 244, (2) through the temperature heat exchanger 246, (3) through the extraction vessel temperature regulator 216, and either (4) through the filtration vessel temperature regulator and then to (4) back to the chiller/heater 244 or directly (4) back to the chiller/heater. A second line can take the following path: (1) out of an additional chiller/heater 244, (2) through the regenerative heat exchanger 248, (3) through the separation chamber temperature regulator 226, (4) through the overflow chamber temperature regulator 226, and (6) back up to the chiller/heater 244.

In some examples, a control system can be equipped with a timer that will automatically shut down the system after a set amount of time has elapsed. The timer can be adjusted at any time during the extraction. Actual time elapsed can be displayed.

In some examples, a flow of the process fluid within in the extraction vessel 210 can be reversed during operation. For example, to back flush a clogged filter, to prevent channeling through the source material, or both. In some examples, one or more of the extraction vessel filters 281 or 282 can be back-flushed when a differential pressure greater than 300 psi exists between the extraction vessel 210 pressure and either the pressure at either of the extraction vessel openings 211 or 212.

According to some examples, a first direction of flow through the extraction vessel 210 can be reversed according to the following steps. Open valve 232.5. Open valve 232.2. Shut valve 232.1. Shut valve 232.6.

According to some examples, following a first reversal of direction of the process fluid, a second direction of flow through the extraction vessel 210 can be reversed according to the following steps. Open valve 232.1. Open valve 232.6. Shut valve 232.5. Shut valve 232.2.

According to some examples, the separation portion 234 may include an orifice and an orifice filter. The orifice and orifice filter can be unclogged according to the following steps. Shut valve 232.2 and valve 232.6 (only one of them will be open). Allow the pump 290 to draw the process fluid out of the separation chamber 220 and overflow chamber 250 and transfer the process fluid to the extraction vessel 210. Optionally, a portion of the process fluid can be transferred back to the process fluid storage container 205 by shutting valves 232.1 and 232.5, throttling valve 232.14 to direct pump output to the process fluid storage container, then shutting valve 232.13 and re-opening valve 1 or 5.

Continuing with the example method for unclogging an orifice and orifice filter, when the separation chamber 220 and overflow chamber 250 reach approximately 70 psi, the pump can be configured to automatically turn off. Shut valve 232.11. Open valve 232.10 to relieve any residual pressure in the separation chamber 220 and overflow chamber 250. Remove the separation chamber top flange 213. Remove the orifice and orifice filter. Clean the orifice and the orifice filter by soaking them in acetone or methanol and blowing them out with compressed air. Verify the orifice is clear by looking through it.

Continuing with the example method for unclogging the orifice and orifice filter, after cleaning the orifice and orifice filter, reassemble the orifice and filter using the provided Teflon tape. Use caution to prevent excess Teflon tape from getting into the orifice. Tighten the orifice assembly such that the orifice points toward the separation vessel inner wall. Replace the separation vessel top flange 213 and tighten the clamp bolts 217 to about 20 ft-lbs. Close valve 232.10. Open valve 232.12. Pressurize separation vessel 220 and overflow chamber 250 to about 300 psi by opening valve 12 and throttling valve 232.11. Close valve 232.11 when separator pressure is approximately 300 psi. In some examples, the pump can be configured to automatically re-start when separator vessel pressure is above about 70 psi. Open valve 232.2 or valve 232.6 (whichever valve was previously opened) to restart the extraction. Shut valve 12. Open valve 232.11. Increase or decrease extractor vessel pressure as described above. Valves can be used to flush/clean the membranes.

If the membrane filter is recommended by the manufacturer to backflush, then the following steps can be taken to backflush the membrane filter. Ensure that valves 332.1 and 332.2 are open, open valve 332.5 to open Line 360 from the compressor, close valves 332.3 and 332.4 and ensure valve 332.6 is closed, and close off valves going into the extraction apparatus. Back pressure regulator 335 is used to set the pressure of the filtration vessel. Allow the membrane to backflush for the manufacturer's recommended time.

Once the extraction is complete to a desired extent, the process fluid can be recovered according to the following method. Increase the temperature of the chiller/heater 244 to at least about 110 F. Open valve 232.6 and shut valve 232.2 (they may already be in this position). Shut valve 1 and valve 5 (only one of them will be open). Open valve 232.13 slowly to allow flow into the process fluid storage container 205. When separation vessel 220 pressure is less than about 200 psi, shut valve 232.6 and open valves 232.2 and 232.8. In some examples, the pump 290 can be configured to shut down automatically when separation chamber pressure reaches about 70 psi. Close process fluid storage container valve. Vent remaining process fluid out of the system by opening valves 232.10, 232.1 and 232.4 and allow residual pressure in the system to vent. The system can now be powered down, or new source material can be loaded and the extraction process started again.

In some examples, the orifice can be sized such that a flow rate of the process fluid into the separation chamber 220 matches a flow rate of the process fluid from the pump 290. In examples, in which the process fluid is supercritical carbon dioxide, the following system parameters and orifice sizes can be used. Chiller/heater temperature: about 110° F. to about 120° F. Extraction vessel pressure: about 1200 psi to about 1400 psi. Orifice size: Size #15 orifice for about 30 cubic feet per minute (CFM) air flow (about 7.5 horse power (HP) air compressor); Size #15 orifice for about 60 CFM air flow (about 15 HP air compressor); Size #25 orifice for about 100 CFM air flow (about 25 HP air compressor). Weight of CO2 in system: approximately 12 pounds for about 5 L extraction vessel systems and about 30 pounds for about 20 L extraction vessel systems. Separation chamber and overflow chamber pressure: about 350 psi to about 400 psi. Separation chamber and overflow chamber temperature: about 70° F. to about 80° F.

In examples, in which the process fluid is subcritical carbon dioxide, the following system parameters and orifice sizes can be used. Chiller/heater temperature: about 60° F. to about 70° F. Extraction pressure: about 1100 psi to about 1400 psi. Orifice size: size #10 orifice for about 30 CFM air flow (about 7.5 HP air compressor); size #15 orifice for about 60 CFM air flow (about 15 HP air compressor); size #20 orifice for about 100 CFM air flow (about 25 HP air compressor). Weight of CO2 in system: approximately 17 pounds for the about 5 L extraction vessel systems and about 45 pounds for the about 20 L extraction vessel systems. Separation chamber and overflow chamber pressure: about 250 psi to about 300 psi. Separation chamber and overflow chamber temperature: about 20° F. to about 30° F.

In subcritical CO2 operation, the extraction vessel 210 can be full of liquid CO2. In such examples, CO2 can be added to the system after extraction has begun in order to maintain a desired extraction pressure.

FIGS. 9-12 disclose other embodiments of systems that can be employed. For example, FIG. 9 schematically depicts a filtration apparatus or system 300 having a filtration vessel 310 and a fluid bypass line 330. One or more valves 332.1, 332.2, 332.3, 332.4, 332.5, 332.6 (e.g., six valves shown) can be included, as well as relief valves 333.1 and 333.2. Embodiments can include a back pressure regulator 335, fluid retentate line 340, fluid permeate line 250, filtration vessel permeate pressure buildup line 360, and filtration vessel permeate vent line 370. System 300 also can include a pressure gauge 371, temperature reading device 373, and pump 395.

During pressurization, valve 332.2 and 332.5 are open to evenly pressurize both sides of the membrane. When desired pressure is achieved, close valve 332.5 and continue with operation.

During venting, valve 332.6 is open and vent valve in extraction apparatus is also open to allow for even pressure drop across the membrane. Valve 332.1 can be opened in addition to or as a replacement to the extraction apparatus vent valve to vent the membrane feed side through the separator apparatus.

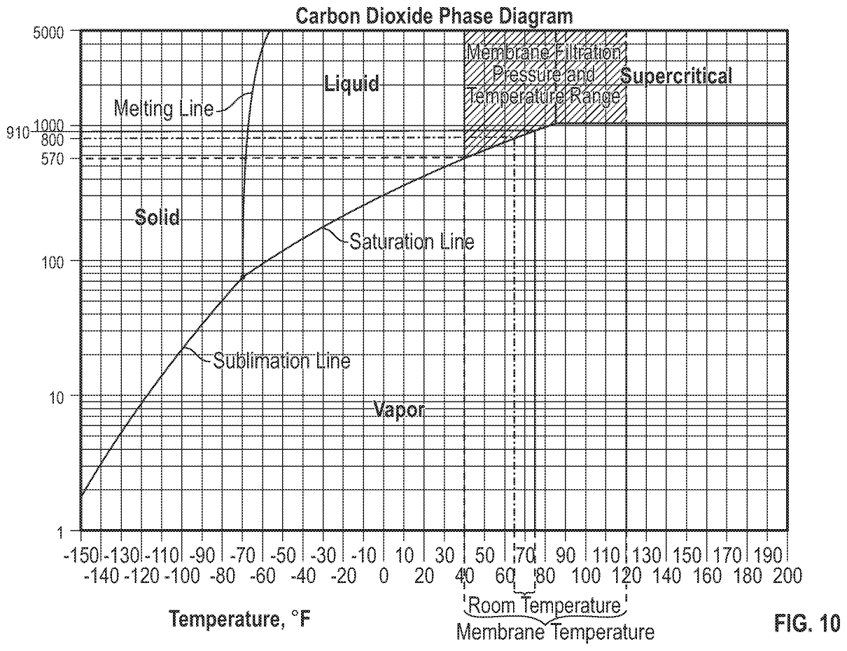

FIG. 10 is a CO₂ phase diagram that depicts some of the useful ranges for the embodiments disclosed herein. FIG. 10 represents the performance of merely one example of a membrane from many optional membranes. This CO₂ phase diagram depicts membrane filtration pressures and operating temperatures for that membrane. Another optional membrane has been tested to an operating temperature of 194° F., as an example.

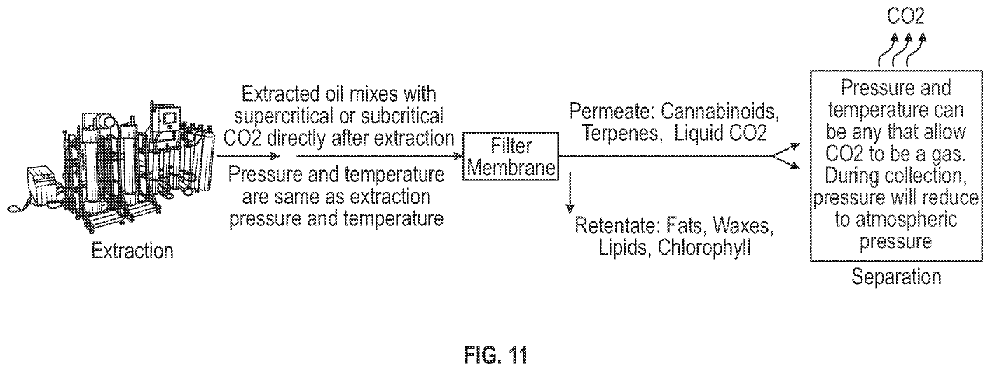

FIG. 11 includes a schematic diagram of an embodiment of a system and method. For example, crude oil may be extracted from the plant material via supercritical and/or subcritical CO2. Next, extracted hemp/cannabis oil is sent through a membrane filter. The removed retentate can include larger undesirables, and the passed through permeate can include smaller desirables. Next, liquid and/or supercritical CO2, cannabinoids, and terpenes can be collected and depressurized. As the solution pressure decreases, the CO2 converts to a gas and naturally separates from the cannabinoids and terpenes. A reduced usage of heat, or even no application of heat is needed for collection of cannabinoids and terpenes. The system can protect heat-sensitive desirables as well as reduce the costs, energy use and time required for the application of heat.

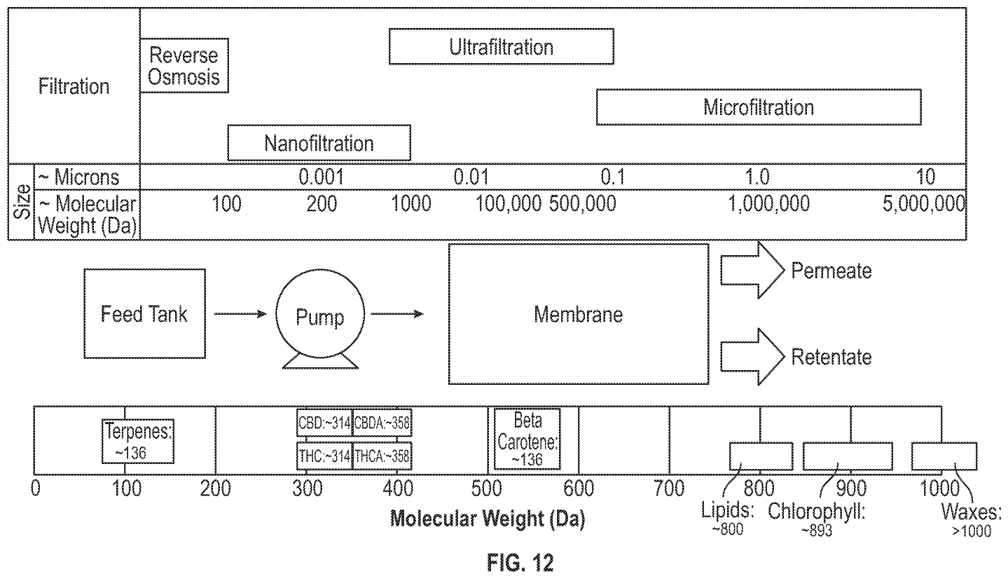

FIG. 12 includes schematic diagrams of embodiments of membrane filtration examples. Membrane filtration can be a pressure-driven separation process based on particulate sizing, such as those shown in the upper, horizontal portion of FIG. 12. In the middle horizontal portion of FIG. 12, solution travels through a selected membrane and smaller particles (permeate) are pushed through the membrane, while larger particles (retentate) are not. The lower horizontal portion of FIG. 12 depicts the interest of the cannabis and hemp industry in the nanofiltration range. Nanofiltration can be suitable for molecular weights of about 100 Da to about 1000 Da. It is suitable for applications such as fine chemistry, pharmaceuticals, oil and petroleum chemistry, natural essential oils and medicine.

The term “supercritical CO2” can be defined as above 88° F. and above 1070 psi. The term “subcritical CO2” can be defined as a minimum of about 910 psi at 75° F., or a minimum of about 800 psi at 65° F. The term “cryogenic CO2” can be defined as about −200° F. to about −300° F. at ambient pressure. The term “ambient room temperature” can be defined as about 65° F. to about 75° F., or about 55° F. to about 85° F. Other definitions also can be used.

The organic material can comprise plant material, such as botanicals, which can be processed by non-thermal processing. In one version, the system does not comprise a cooling system. In another version, the process temperature range can include supercritical CO2, which could include a cooling system. Some versions of the system do not include any vessel/building requirements that are normally required for flammable/explosive solvents. Additional programming/sensors can be include for enhanced automation.

In some embodiments, the filter membranes can be conventional. In other embodiments, new membrane designs can be deployed, such as to work more effectively with CO2. In one example, conventional processing equipment can be included to recycle the CO2 back to the storage tanks as the CO2 is depressurized.

In general, the membranes can work at the same operating conditions as the extractors. Operating conditions can go up to higher pressures (e.g., about 5000 psi) and the system can still function. The membranes can work with any subcritical or supercritical parameters. Valving can be used to control the transmembrane pressure and flowrate to allow for proper usage of the membranes.

Without the requirement of heat from evaporation techniques used for conventional solvent removal, the following advantages can be provided by the embodiments disclosed herein:
heat-sensitive products like terpenes are unaffected
acidic forms of cannabinoids stay intact since there is no addition of heat
evaporation techniques can be partially or completely removed to reduce cost, energy, and time requirements to obtain final product (e.g., rotary evaporator, distillation, etc.)
CO2 can be used to clean oils and residues from any material or decontamination of materials; CO2 can be used to remove oils and other materials or compounds that are soluble in CO2.

Other examples can include one or more of the following items.

1. A system for processing organic material, the system comprising:

an extraction system for extracting soluble compounds from organic material using a compressed solvent to form diluted soluble compounds;

a filter system for filtering the diluted soluble compounds through a membrane filter that can:
remove a retentate comprising undesirable components; and
permit passage of a permeate comprising desirable components and the compressed solvent, wherein the undesirable components comprise a larger molecular weight than the desirable components; and the system further comprises:

a depressurization system for depressurizing the permeate and the compressed solvent, and separating the desirable components from the permeate and the compressed solvent.

2. The system wherein the extraction system and filter system can process the compressed solvent at a pressure in a range of about 570 psi to not greater than about 5000 psi.

3. The system wherein the extraction system and the filter system can process the compressed solvent at a temperature in a range of about 40′F to about 120° F.

4. The system wherein the filter system comprises a pump and at least one of microfiltration, ultrafiltration, nanofiltration or reverse osmosis filtration.

5. The system wherein the retentate comprises at least one of fats, waxes, lipids or chlorophyll.

6. The system wherein the permeate comprises at least one of cannabinoids or terpenes.

7. The system wherein the depressurization system can operate without additional heat such that separation of the desirable components from the permeate and the compressed solvent can occur at ambient room temperature.

8. The system wherein, other than the depressurization system, the system does not comprise an evaporation system, rotary evaporator or distillation system to separate the desirable components from the compressed solvent.

9. The system wherein the extraction system, filter system and depressurization system comprise a continuous, integrated system.

10. The system wherein the extraction system, filter system and depressurization system comprise a batch processing system.

11. The system of claim 1, wherein the filter system can receive the diluted soluble compounds directly from the extraction system, and the depressurization system can receive the permeate directly from the filter system.

12. The system wherein the filter system and the depressurization system can operate at ambient room temperature.

13. The system wherein an entirety of the system can operate at ambient room temperature.

14. The system wherein the system can operate at a ratio of the compressed solvent to the soluble compounds, and the ratio is in a range of about 4:1 to about 20:1.

15. The system wherein the compressed solvent comprises liquid CO2.

16. The system wherein the membrane filter comprises at least one of polymer or ceramic material.

17. The system wherein the filter system comprises a filtration vessel having one or more filters.

18. The system wherein the filter system comprises a plurality of filtration vessels that are coupled in at least one of in parallel or in series.

19. The system wherein the system further comprises an additional extraction system that can process the retentate for batch recirculation without an additional pump.

20. The system further comprising a temperature regulator that can regulate a temperature within the filter system.

21. The system wherein the system can operate at any temperature and pressure that enables CO2 to be in a subcritical or supercritical fluid phase.

22. The system wherein the depressurization system can depressurize the compressed solvent to convert from a liquid to a gas.

23. Devices for processing organic material, the devices comprising:

an extraction system configured to extract soluble compounds from organic material using a compressed solvent to form diluted soluble compounds;

a filter system configured to be coupled to the extraction system to filter the diluted soluble compounds through a membrane filter that is configured to:
remove a retentate comprising undesirable components; and
permit passage of a permeate comprising desirable components and the compressed solvent, wherein the undesirable components comprise a larger molecular weight than the desirable components; and the devices further comprise:

a depressurization system configured to be coupled to the filter system to depressurize the permeate and the compressed solvent, and separate the desirable components from the compressed solvent.

24. A method of processing organic materials, the method comprising:

extracting soluble compounds from organic material using a compressed solvent to form diluted soluble compounds;

filtering the diluted soluble compounds through a membrane filter, removing a retentate comprising undesirable components and permitting passage of a permeate comprising desirable components and the compressed solvent, such that the undesirable components comprise a larger molecular weight than the desirable components;

depressurizing the permeate and the compressed solvent; and

separating the desirable components from the permeate and the compressed solvent.

This written description uses examples to disclose the embodiments, including the best mode, and also to enable those of ordinary skill in the art to make and use the invention. The patentable scope is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Note that not all of the activities described above in the general description or the examples are required, that a portion of a specific activity may not be required, and that one or more further activities can be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

It can be advantageous to set forth definitions of certain words and phrases used throughout this patent document. The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, can mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C.

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. As used herein, the terms “substantial” and “substantially” means, when comparing various parts to one another, that the parts being compared are equal to or are so close enough in dimension that one skill in the art would consider the same. Substantial and substantially, as used herein, are not limited to a single dimension and specifically include a range of values for those parts being compared. The range of values, both above and below (e.g., “+/−” or greater/lesser or larger/smaller), includes a variance that one of skill in the art would know to be a reasonable tolerance for the parts mentioned.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or essential feature of any or all the claims.

After reading the specification, skilled artisans will appreciate that certain features which, for clarity, are described herein in the context of separate embodiments, can also be provided in combination in a single embodiment. Conversely, various features that are, for brevity, described in the context of a single embodiment, can also be provided separately or in any subcombination. Further, references to values stated in ranges include each and every possible value within that range.

We claim:

1. A system for processing organic material, the system comprising:
an extraction system for extracting soluble compounds from organic material using a compressed solvent to form diluted soluble compounds;
a filter system for filtering the diluted soluble compounds through a membrane filter that can:
remove a retentate comprising undesirable components; and
permit passage of a permeate comprising desirable components and the compressed solvent, wherein the undesirable components comprise a larger molecular weight than the desirable components; and the system further comprises:
a depressurization system for depressurizing the permeate and the compressed solvent, and separating the desirable components from the permeate and the compressed solvent.

2. The system of claim 1, wherein the extraction system and filter system can process the compressed solvent at:
a pressure in a range of about 570 psi to not greater than about 5000 psi; and
a temperature in a range of about 40° F. to about 120° F.

3. The system of claim 1, wherein the filter system comprises a pump and nanofiltration.

4. The system of claim 1, wherein the retentate comprises at least one of fats, waxes, lipids or chlorophyll.

5. The system of claim 1, wherein the permeate comprises at least one of cannabinoids or terpenes.

6. The system of claim 1, wherein the depressurization system can operate without additional heat such that separation of the desirable components from the permeate and the compressed solvent can occur at ambient room temperature.

7. The system of claim 1 wherein, other than the depressurization system, the system does not comprise an evaporation system, rotary evaporator or distillation system to separate the desirable components from the compressed solvent.

8. The system of claim 1, wherein the extraction system, filter system and depressurization system comprise a continuous, integrated system.

9. The system of claim 1, wherein the extraction system, filter system and depressurization system comprise a batch processing system.

10. The system of claim 1, wherein the filter system can receive the diluted soluble compounds directly from the extraction system, and the depressurization system can receive the permeate directly from the filter system.

11. The system of claim 1, wherein the filter system and the depressurization system can operate at ambient room temperature.

12. The system of claim 1, wherein an entirety of the system can operate at ambient room temperature.

13. The system of claim 1, wherein the system can operate at a ratio of the compressed solvent to the soluble compounds, and the ratio is in a range of about 4:1 to about 20:1.

14. The system of claim 1, wherein the compressed solvent comprises liquid CO₂.

15. The system of claim 1, wherein the membrane filter comprises at least one of polymer or ceramic material.

16. The system of claim 1, wherein the filter system comprises a plurality of filtration vessels that are coupled in at least one of in parallel or in series, and each filtration vessel comprises one or more filters.

17. The system of claim 1, further comprising:
an additional extraction system that can process the retentate for batch recirculation without an additional pump; and
a temperature regulator that can regulate a temperature within the filter system.

18. The system of claim 1, wherein the system can operate at any temperature and pressure that enables CO₂ to be in a subcritical or supercritical fluid phase; and
the depressurization system can depressurize the compressed solvent to convert from a liquid to a gas.

19. Devices for processing organic material, the devices comprising:
an extraction system configured to extract soluble compounds from organic material using a compressed solvent to form diluted soluble compounds;
a filter system configured to be coupled to the extraction system to filter the diluted soluble compounds through a membrane filter that is configured to:
remove a retentate comprising undesirable components; and
permit passage of a permeate comprising desirable components and the compressed solvent, wherein the undesirable components comprise a larger molecular weight than the desirable components; and the devices further comprise:
a depressurization system configured to be coupled to the filter system to depressurize the permeate and the compressed solvent, and separate the desirable components from the compressed solvent.

20. A method of processing organic materials, the method comprising:
extracting soluble compounds from organic material using a compressed solvent to form diluted soluble compounds;
filtering the diluted soluble compounds through a membrane filter, removing a retentate comprising undesirable components and permitting passage of a permeate comprising desirable components and the compressed solvent, such that the undesirable components comprise a larger molecular weight than the desirable components;
depressurizing the permeate and the compressed solvent; and
separating the desirable components from the permeate and the compressed solvent.
